(19) United States
(12) Patent Application Publication
(10) Pub. No.: US 2004/0162720 A1
(43) Pub. Date: Aug. 19, 2004

(54) Audio data encoding apparatus and method

(75) Inventors: Heung-Yeop Jang, Suwon-si (KR); Byoung-Il Kim, Seoul (KR); Tae-Gyu Chang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/725,433

(22) Filed: Dec. 3, 2003

(30) Foreign Application Priority Data
Feb. 15, 2003 (KR) 2003-9607

(51) Int. Cl. G10L 19/00

(52) U.S. Cl. 704/200.1

(57) ABSTRACT

An apparatus and method for encoding audio data with a small amount of computation are provided. The audio data encoding apparatus includes: a time-to-frequency converting unit that receives a time domain audio signal and converts the same to a frequency domain audio signal; a spectral processor that performs spectral processing on the frequency domain audio signal; a masking threshold calculator that calculates an energy level for each frequency band of the frequency domain audio signal, approximates an energy distribution curve connecting the calculated energy levels to a distribution pattern similar to that of noise threshold levels calculated by a conventional psychoacoustic model, and calculates a scalefactor band gain for each band; and a quantization noise curve adjuster that adjusts a common gain to meet a target bit rate and matches a quantization noise curve to the approximated energy distribution curve while fixing the scalefactor gain for each frequency band.

### BACKGROUND OF THE INVENTION

This application claims priority from Korean Patent Application No. 2003-9607, filed Feb. 15, 2003, the contents of which are incorporated herein by reference in their entirety.

1. Field of the Invention

The present invention relates to audio data encoding, and more particularly, to an apparatus and method for encoding data with a small amount of computation.

2. Description of the Related Art

Encoders that compress audio data according to a predetermined standard use a psychoacoustic model and control quantization noise for each frequency band in a multi-stage control loop based on the calculations performed by the psychoacoustic model. Here, quantization is the process of converting a sampled signal value into a particular representative value, which is an integer value step, and introduces quantization noise. The quantization noise that is the error between the original signal and quantized signal decreases as the number of bits used in quantization increases. MPEG, which is a standard for compressing moving pictures and audio, divides a Discrete Cosine Transform (DCT) or Modified Discrete Cosine Transform (MDCT) coefficient calculated by DCT or MDCT process by a predetermined value to obtain a small coefficient, thereby reducing the amount of data to be encoded.

The multi-stage control loop used for conventionally adjusting the distribution of quantization noise consists of an inner loop that adjusts a common gain applied over all frequency bands and matches the amount of bits used to a specified bit rate, and an outer loop that adjusts a scalefactor band gain so that the amount of quantization noise can be adjusted for each band. The inner loop encodes an audio signal by applying a scalefactor band gain adjusted for each band, and sums the amount of bits used for each band. If the summed value is found to exceed a predetermined threshold, the inner loop increases the common gain so that the amount of bits used is below the threshold, while the outer loop increases a scalefactor band gain for each band by a predetermined amount so that the number of bits cannot exceed a threshold given for each band. The adjustment process is repeated until the quantization noise for every band is below the given threshold.

Typically, encoding audio data requires an amount of computation that is 10 times more than decoding the same. An encoder becomes more complicated since Fast Fourier Transform (FFT) analysis, calculation of tonality and masking threshold, and processing between frames performed by a psychoacoustic model accounts for 50% of the total amount of computation while multi-stage control loop operation for controlling bit rate and noise constitutes 40%.

FIG. 1 is a block diagram of a conventional audio encoder. The audio encoder consists of a time-to-frequency converting unit 110, a spectral processor 120, a quantizer 130, a psychoacoustic model 140, a bit allocating unit 150, and a bitstream generator 160.

The time-to-frequency converting unit 110 receives Pulse Code Modulation (PCM) audio data in the time domain and converts the same into a frequency domain signal. Different processing techniques are used in the time-to-frequency converting unit 110, depending on the encoding format. For example, MDCT may be performed when encoding the audio data according to Advanced Audio Coding (AAC) or MP3 (MPEG-1 layer 3) format.

The spectral processor 120 performs spectral processing on the frequency domain signal according to an audio encoding format. Examples of the spectral processing include Temporal Noise Shaping (TNS), Long Term Prediction (LTP), Perceptual Noise Substitution (PNS), I/C, and M/S. The quantizer 130 performs quantization on the frequency domain audio data that have undergone the spectral processing.

The psychoacoustic model 140, consisting of an FFT performing unit 141 and a masking threshold calculator 142, reflects the characteristics of human auditory characteristics in the frequency domain. The processing conducted by the psychoacoustic model 140 will be described later. The characteristics of the human auditory perception in the frequency domain will now be described with references to FIGS. 2A and 2B.

FIGS. 2A and 2B explain a masking effect. As illustrated in FIG. 2A, when an audio signal A (210) having a predetermined sound pressure exists, an audio signal B (220) having a sound pressure level less than the audio signal A (210) is inaudible to a human listener. A masking curve 230 shows a minimum sound pressure level at which the human listener can hear a particular audio signal within an audible frequency range. The audio signal B (220) at the level below the masking curve 230 cannot be perceived by a human ear while an audio signal C (240) at level above the curve 230 is audible.

If several peak values 250, 260, and 270 are present as shown in FIG. 2B, masking curves 251, 261, and 271 corresponding to those peak values 250, 260, and 270 are connected to obtain the overall masking curve.

In this way, quantization using a psychoacoustic model is done to divide the audible frequency range into a number of frequency sub-bands of equal width and quantize only audio data having a sound pressure level above the masking threshold. This quantization is used for a compression method such as MPEG. However, since there is a limit on the number of bits available for quantization when compressing an audio signal at a low bit rate of less than 64 Kbps, a typical audio compression method specified in MPEG standard is not suitable for effectively encoding an audio signal.

The bit allocating unit 150 receives the calculation result from the psychoacoustic model 140 and performs a bit allocation procedure. The bitstream generator 160 then packs the quantized audio data according to a specified format.

A conventional MPEG audio encoding process will now be described. MPEG encoding algorithm is described in detail in ISO/IEC 14496-3.

First, to convert a time domain signal into a frequency domain signal, the time-to-frequency converting unit 110 receives PCM audio data which is also input to a psychoacoustic model 140. The psychoacoustic model 140, which reflects the characteristics of human auditory system with respect to a frequency domain, converts the input audio data into frequency domain data using FFT and divides the frequency domain into a number of critical bands where common human hearing characteristics are similar. A sound pressure level at which a signal component within an adjacent critical band can be perceived rises (See FIGS. 2A and 2B), which is called a masking effect.

Then, using the masking effect of the converted frequency domain audio data, a masking threshold is calculated for each critical band. In this case, taking the masking effect into account, it is necessary to determine whether the frequency domain audio data is a tonal or noise component. That is, to prevent a noise component from being selected as a tonal component, linear prediction is performed using the previously input two blocks of frequency components to determine whether the audio data is a tonal component.

When signals of high and low sound pressure levels are contained within one block signal interval in the time domain, a pre-echo effect occurs where the quantization noise of the signal of the high sound pressure level is included in the signal of the low sound pressure level so the noise is heard. To prevent this pre-echo effect, frequency conversion is performed on one block using a short window block where one block is divided into eight intervals instead of a long window block. The psychoacoustic model 140 calculates perceptual entropy to switch between long and short window blocks.

Then, the spectral processor 120 removes redundancy between signal components represented in the frequency domain for compressing audio data.

The frequency domain signal components are identified on a scalefactor basis, each signal component representing a multiplication of a gain commonly applied in the corresponding scalefactor band by a quantized value. The major factors in determining the gain are a common gain for all frequency bands and a scalefactor applied to each scalefactor band. The common gain is adjusted to meet a target bit rate, and the scalefactor is used to adjust the quantization noise for each scalefactor band. The quantization noise allowable for each scalefactor band is determined using the masking threshold calculated by the psychoacoustic model 140.

To calculate the masking threshold in the psychoacoustic model 140, the conventional audio encoding method involves FFT operation for conversion into the frequency domain, processing of a spreading function using the masking effect, and calculation of tonality through linear prediction between frames. This requires a considerable amount of computation. In addition to the FFT operation performed by the psychoacoustic model 140, DCT is performed on the time domain signal for signal processing in the frequency domain. Thus, this method significantly increases the time required for data processing by an encoder. That is, while the conventional MPEG audio compression method uses the psychoacoustic model to obtain a high quality reproduced audio signal, this inevitably results in complicated data processing and increased amount of computations.

In the quantization process, adjusting the quantization noise using bit allocation for each frequency band and meeting the overall bit rate are repeated until the quantization noise is within the maximum allowable value while meeting a desired bit rate. However, audio encoding at a low bit rate has a problem that a small number of bits available for each block is used to complete the quantization process before the quantization noise for each frequency is less than the allowable value calculated by the psychoacoustic model.

### SUMMARY OF THE INVENTION

The present invention provides an audio data encoding apparatus and method that estimate a psychoacoustic model with a smaller amount of computation by calculating energy distribution for each band of an audio signal instead of using the psychoacoustic model that requires complicated computation in performing conventional audio encoding.

The present invention also provides an audio data encoding apparatus and method designed to eliminate repeated processing that was used in a conventional quantization noise adjustment method for meeting both bit rate and quantization noise distribution requirements and to prevent occurrences of large degradation in sound quality due to completion of a quantization process before the quantization noise is appropriately distributed during low bit rate encoding.

According to an aspect of the present invention, there is provided an audio data encoding apparatus including: a time-to-frequency converting unit that receives a time domain audio signal and converts the same to a frequency domain signal; a spectral processor that receives the frequency domain audio signal and performs spectral processing on the frequency domain signal according to an audio encoding format; a masking threshold that receives the frequency domain audio signal, calculates an energy level for each frequency band, approximates an energy distribution curve connecting the calculated energy levels to a distribution pattern similar to that of noise threshold levels calculated by a conventional psychoacoustic model, and calculates a scalefactor band gain for each band; and a quantization noise curve adjuster that adjusts a common gain to meet a target bit rate and matches a quantization noise curve to the approximated energy distribution curve while fixing the scalefactor gain for each frequency band.

A quantization noise distribution adjusting unit according to this invention includes: a masking threshold that receives a frequency domain audio signal, calculates an energy level for each frequency band, approximates an energy distribution curve connecting the calculated energy levels to a distribution pattern similar to that of noise threshold levels calculated by a conventional psychoacoustic model, and calculates a scalefactor band gain for each frequency band; and a quantization noise curve adjuster that adjusts a common gain to meet a target bit rate and matches a quantization noise curve to the approximated energy distribution curve while fixing the scalefactor gain for each frequency band.

According to another aspect of the present invention, there is provided an audio data encoding method including the steps of: (a) receiving a time domain audio signal and converting the same to a frequency domain signal; (b) performing spectral processing on the frequency domain signal according to an audio encoding format; (c) receiving the frequency domain audio signal, calculating an energy level for each frequency band, approximating an energy distribution curve connecting the calculated energy levels to a distribution pattern similar to that of noise threshold levels calculated by a conventional psychoacoustic model, and calculating a scalefactor band gain for each frequency band; and (d) adjusting a common gain to meet a target bit rate and matching a quantization noise curve to the approximated energy distribution curve while fixing the scalefactor band gain for each frequency band.

A quantization noise distribution adjustment method according to this invention includes the steps of: (a) receiving a frequency domain audio signal, calculating an energy level for each frequency band, approximating an energy distribution curve connecting the calculated energy levels to a distribution pattern similar to that of noise threshold levels calculated by a conventional psychoacoustic model, and calculating a scalefactor band gain for each frequency band; and (b) adjusting a common gain to meet a target bit rate and matching a quantization noise curve to the approximated energy distribution curve while fixing the scalefactor band gain for each frequency band.

According to yet another aspect of the present invention, there is provided a computer-readable recording medium that records a program for executing the above methods on a computer.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of a conventional audio encoder;

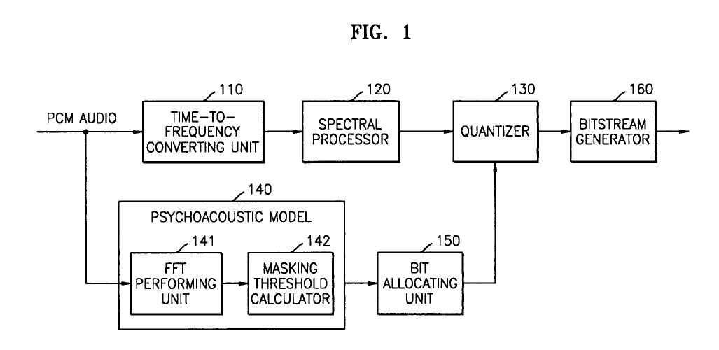

FIGS. 2A and 2B explain a masking effect;

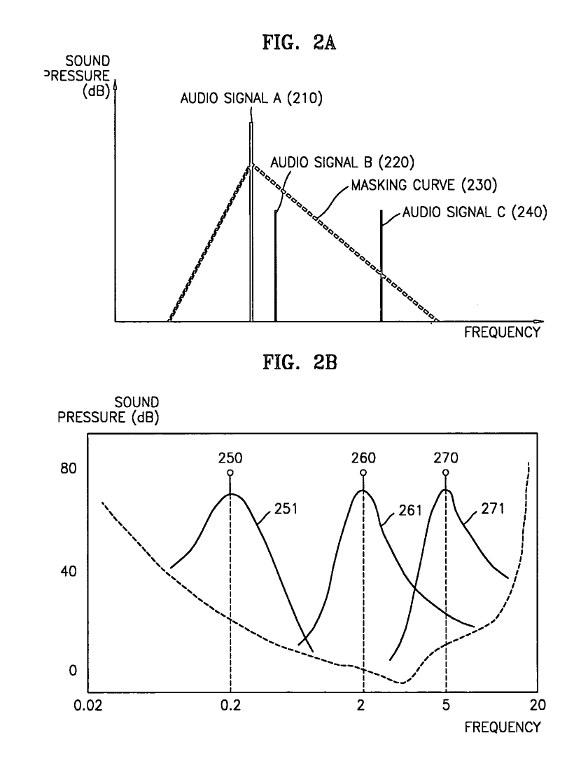

FIG. 3 is a block diagram of an audio data encoding apparatus according to the present invention;

FIGS. 4A-4D explain the process of approximating energy in a scalefactor band; and

FIG. 5 is a flowchart illustrating an audio data encoding method according to this invention.

### DETAILED DESCRIPTION OF THE INVENTION

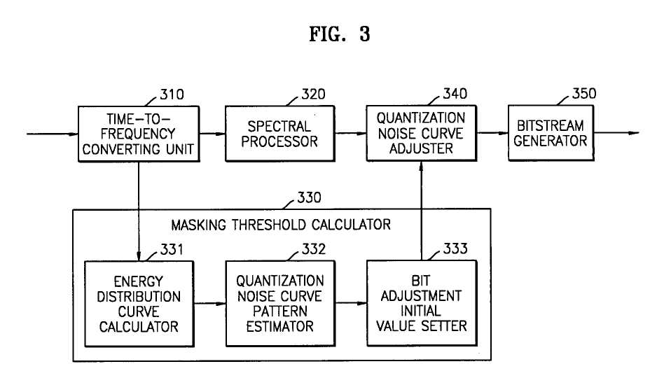

Referring to FIG. 3, an audio data encoding apparatus according to this invention is comprised of a time-to-frequency converting unit 310, a spectral processor 320, a masking threshold calculator 330, a quantization noise curve adjuster 340, and a bitstream generator 350.

The time-to-frequency converting unit 310 converts a time domain signal to a frequency domain signal. Different processing techniques are used in the time-to-frequency converting unit 310 depending on the encoding format. For example, Modified Discrete Cosine Transform (MDCT) may be performed when encoding the audio data according to Advanced Audio Coding (AAC) or MP3 (MPEG-1 layer 3) format. The spectral processor 120 performs spectral processing on the frequency domain signal according to an audio encoding format. Examples of the spectral processing include Temporal Noise Shaping (TNS), Long Term Prediction (LTP), Perceptual Noise Substitution (PNS), I/C, and M/S.

The masking threshold calculator 330 consists of an energy distribution curve calculator 331, a quantization noise curve pattern estimator 332, and a bit adjustment initial value setter 333. The masking threshold calculator 330 performs MDCT on the incoming audio data, calculates an energy level for each frequency band, approximates the calculated energy level curve to a distribution pattern similar to that of noise threshold levels calculated by a psychoacoustic model, and calculates a scalefactor gain for each band.

That is, the energy distribution curve calculator 331 performs MDCT on the incoming audio data to calculate an energy level for each frequency band. The quantization noise curve pattern estimator 332 relatively adjusts a gain for each band based on the calculated energy distribution curve and sets the distribution of quantization noise. The bit adjustment initial value setter 333 determining only a scalefactor band gain uses more bits than the number of bits corresponding to the given target bit rate, since the common gain has an initial value.

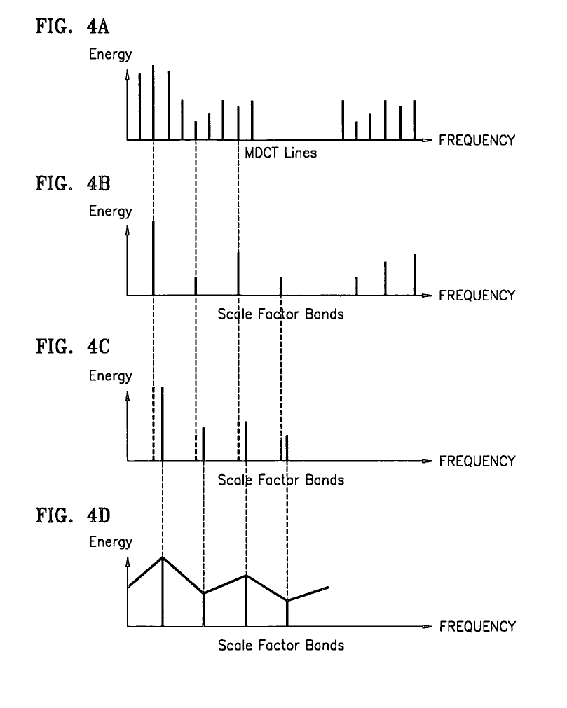

FIGS. 4A-4D illustrate the process of approximating energy in a scalefactor band. Once MDCT has been performed on the incoming audio data, MDCT lines are obtained as shown in FIG. 4A. FIG. 4B shows a state in which several MDCT lines have been grouped for each scalefactor band. Then, energy for each scalefactor band is adjusted as shown in the solid line in FIG. 4C. If an energy level in one of the adjacent scalefactor bands is larger than that in a particular scalefactor band, the energy level in the scalefactor band is increased. If not, it remains intact. This is defined by Equation (1):

M(sfb)=E(Sfb)+α|E(sfb−1)−E(sfb)|+β|E(sfb+1)−E(sfb)| (1)

where sfb and M(sfb) denote scalefactor band and scalefactor energy approximated for each scalefactor band, respectively.

FIG. 4D shows an approximated scalefactor energy curve. A scalefactor band gain sfbgain(sfb) is calculated by Equation (2) using the estimated scalefactor energy M(sfb):

sfbgain(sfb)=y|M(sfb)−E(sfb)|^{θ} (2)

While fixing the scalefactor gain thus determined for each band, the quantization noise curve adjuster 340 adjusts a common gain for all frequency bands to meet a target bit rate and matches a quantization noise curve to the energy distribution curve. That is, the quantization noise curve adjuster 340 compares the number of bits available for a given bit rate with the number of bits used. If the latter is smaller than the former, encoding is performed using the bits. If not, adjustment of the quantization noise curve is repeated again.

In this way, the audio data encoding apparatus according to this invention calculates from a frequency component derived by DCT an approximated noise threshold level, which is similar to a noise threshold level calculated by a psychoacoustic model and processed in a simple way, instead of using a psychoacoustic model in order to calculate a noise threshold level according to which quantization noise is distributed for each frequency band. That is, the audio data encoding apparatus of this invention relatively adjusts a scalefactor gain which is the ratio of quantization noise distributed for each band to have the same pattern as the approximated noise threshold level distribution, instead of performing a loop several times for repeatedly adjusting common gain and scalefactor gain in order to meet a target bit rate while keeping the quantization noise below a noise threshold level. Then, it adjusts a common gain for all frequency bands in order to meet the given target bit rate while fixing the relatively adjusted scalefactor band gain.

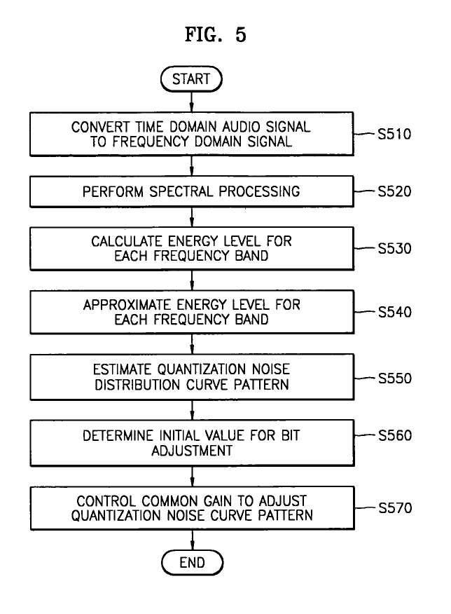

FIG. 5 is a flowchart illustrating an audio data encoding method according to this invention. An MPEG-4 AAC encoding algorithm based on simple matching to an energy distribution curve for encoding audio data at high speed while preventing sound quality degradation will now be described with reference to FIG. 5 as an embodiment of this invention.

In step S510, a time domain audio signal is converted to a frequency domain signal. In step S520, spectral processing is performed on the frequency domain signal to reduce excessive information contained in the frequency domain signal.

In step S530, the frequency domain signal is simply used to calculate an energy level for each frequency band instead of using a psychoacoustic model requiring a complicated computational process in order to calculate a noise threshold level. In step S540, the energy level for each frequency band is approximated to make it similar to a noise threshold level computed through a psychoacoustic model. That is, if an energy level in one of adjacent frequency bands is greater than that in a particular band, the energy level in the particular band is increased by a predetermined ratio with respect to the difference with the greater energy level in its adjacent band. Specifically, the energy level is increased by the amount as described by Equation (1).

Then, in step S550 the pattern of a quantization noise distribution curve is estimated through the adjusted energy level distribution pattern. The largest energy level is found among all frequency bands of the input audio frame and a gain, i.e., a scalefactor band gain for each frequency band is determined according to the difference between the largest energy level and an energy level for each frequency band. Through this process, the quantization noise distribution for each frequency band has a pattern approximated in the form of noise threshold computed from a psychoacoustic model.

In step S560, an initial value for bit adjustment is determined to match the quantization noise distribution to an approximated energy level according to the given target bit rate. In step S570, while fixing the scalefactor band gain for each frequency band computed in the step S550, a common gain for all frequency bands is adjusted to meet the target bit rate. In this way, the quantization noise is approximated in the pattern of energy level distribution.

Embodiments of the present invention can be written as a computer-readable code on a computer-readable recording medium. Examples of the computer-readable recording medium may include a ROM, a RAM, a CD-ROM, a magnetic tape, a floppy disk, and an optical data storage device. The code may also be transmitted in carrier waves e.g., via the Internet. Furthermore, the computer-readable code may be stored or executed on the recording media scattered on computer systems which are connected to one another by a network.

While this invention has been particularly shown and described with reference to a preferred embodiment thereof, it will be understood by those skilled in the art that various changes in form and details may be made therein without departing from the spirit and scope of the invention as defined by the appended claims. Therefore, the described embodiments should be considered not in terms of restriction but in terms of explanation. The scope of the present invention is limited not by the foregoing but by the following claims, and all differences within the range of equivalents thereof should be interpreted as being covered by the present invention.

As described above, the audio data encoding apparatus and method according to this invention have the following advantages over the conventional ones.

First, this invention can implement a simple encoder by deriving the quantization noise distribution pattern similar to the relative distribution of a noise threshold level for each frequency band using energy distribution for each band instead of directly using a psychoacoustic model required for conventional audio encoding.

Second, while conventional quantization directly affects degradation in sound quality by inefficiently allocating bits with the restricted number of bits, this invention first adjusts the relative distribution of quantization noise for each band by adjusting a gain for each band according to the approximated noise level distribution before adjusting a bit rate. After performing matching of quantization noise to energy distribution in which bit rate adjustment follows relative adjustment of quantization noise, this invention can significantly reduce the tremendous amount of computation resulting from a conventional quantization loop process while improving sound quality by obtaining a quantization noise distribution pattern similar to amplitude distribution of noise threshold levels.

Third, this invention meets a bit rate by approximating a quantization noise curve in the same pattern as approximated noise threshold level distribution instead of making the curve equal to the noise threshold level distribution. This prevents the quantization noise from exceeding the allowed threshold to a great extent thus significantly reducing the occurrences of sound quality degradation caused during audio encoding. Furthermore, this invention eliminates the need for a complicated computation process for calculating a noise threshold level from a psychoacoustic model as well as a process of repeatedly adjusting the quantization noise according to an absolute value of a noise threshold and meeting a bit rate, thus allowing for high speed audio encoding.

What is claimed is:

1. An audio data encoding apparatus comprising:
a time-to-frequency converting unit that receives a time domain audio signal and converts the time domain audio signal to a frequency domain audio signal;
a spectral processor that receives the frequency domain audio signal and performs spectral processing on the frequency domain signal according to an audio encoding format;
a masking threshold calculator that receives the frequency domain audio signal, calculates an energy level for each frequency band of the frequency domain audio signal, approximates an energy distribution curve connecting the calculated energy levels to a distribution pattern of noise threshold levels calculated by a psychoacoustic model, and calculates a scalefactor band gain for each frequency band; and
a quantization noise curve adjuster that adjusts a common gain to meet a target bit rate and matches a quantization noise curve to the approximated energy distribution curve while fixing the scalefactor gain for each frequency band.

2. The apparatus of claim 1, wherein the time-to-frequency converting unit performs Modified Discrete Cosine Transform (MDCT) on the input time domain signal.

3. The apparatus of claim 1, wherein the spectral processor performs Temporal Noise Shaping (TNS), Long Term Prediction (LTP), or Perceptual Noise Substitution (PNS) according to an audio encoding format.

4. The apparatus of claim 1, wherein the masking threshold calculator comprises:
an energy distribution curve calculator that performs Modified Discrete Cosine Transform (MDCT) on the frequency domain audio signal to calculate the energy level for each frequency band;
a quantization noise curve pattern estimator that adjusts quantization noise distribution by relatively adjusting a gain for each frequency band based on the calculated energy distribution curve; and
a bit adjustment initial value setter that determines the scalefactor band gain in such a way as to use more bits than the target bit rate.

5. The apparatus of claim 1, wherein the quantization noise curve adjuster compares the number of bits available for a given bit rate with the number of bits used, and if the number of bits used is smaller than the number of bits available, performs encoding using the number of bits available, or, if the number of bits used is not smaller than the number of bits available, repeats matching of the quantization noise curve.

6. A quantization noise distribution adjusting unit comprising:
a masking threshold calculator that receives a frequency domain audio signal, calculates an energy level for each frequency band of the frequency domain audio signal, approximates an energy distribution curve connecting the calculated energy levels to a distribution pattern of noise threshold levels calculated by a psychoacoustic model, and calculates a scalefactor band gain for each frequency band; and
a quantization noise curve adjuster that adjusts a common gain to meet a target bit rate and matches a quantization noise curve to the approximated energy distribution curve while fixing the scalefactor gain for each frequency band.

7. An audio data encoding method comprising the steps of:
(a) receiving a time domain audio signal and converting the time domain audio signal to a frequency domain signal;
(b) performing spectral processing on the frequency domain signal according to an audio encoding format;
(c) receiving the frequency domain signal, calculating an energy level for each frequency band of the frequency domain signal, approximating an energy distribution curve connecting the calculated energy levels to a distribution pattern of noise threshold levels calculated by a psychoacoustic model, and calculating a scalefactor band gain for each frequency band; and
(d) adjusting a common gain to meet a target bit rate and matching a quantization noise curve to the approximated energy distribution curve while fixing the scalefactor band gain for each frequency band.

8. The method of claim 7, wherein the step (c) comprises the steps of:
(c1) calculating an energy level for each frequency band with the frequency domain signal;
(c2) approximating the energy level for each frequency band;
(c3) estimating the pattern of a quantization noise distribution curve using a distribution pattern of the approximated energy levels; and
(c4) determining an initial value for bit adjustment in order to match the quantization noise distribution curve to the energy level for each frequency band according to a target bit rate and calculating a scalefactor band gain for each frequency band.

9. The method of claim 8, wherein in the step (c2), if a signal in one of adjacent frequency bands has an energy level greater than that of a signal in a particular frequency band, the energy level of the signal in the particular band is increased by a predetermined ratio with respect to a difference with the greater energy level in the adjacent frequency band.

10. The method of claim 8, wherein in the step (c3), a signal having a largest energy level is found among signals in all frequency bands, a gain for each frequency band is determined according to a difference between the largest energy level and an energy level of a signal in each frequency band, and quantization noise distribution for each frequency band is approximated in the form of a noise threshold.

11. A quantization noise distribution adjustment method comprising the steps of:
(a) receiving a frequency domain audio signal, calculating an energy level for each frequency band of the frequency domain audio signal, approximating an energy distribution curve connecting the calculated energy levels to a distribution pattern of noise threshold levels calculated by a psychoacoustic model, and calculating a scalefactor band gain for each frequency band; and
(b) adjusting a common gain to meet a target bit rate and matching a quantization noise curve to the approximated energy distribution curve while fixing the scalefactor band gain for each frequency band.

12. A computer-readable recording medium that records a program for executing an audio data encoding method on a computer, the method comprising the steps of:
(a) receiving a time domain audio signal and converting the time domain audio signal to a frequency domain signal;
(b) performing spectral processing on the frequency domain signal according to an audio encoding format;
(c) receiving the frequency domain signal, calculating an energy level for each frequency band of the frequency domain signal, approximating an energy distribution curve connecting the calculated energy levels to a distribution pattern of noise threshold levels calculated by a psychoacoustic model, and calculating a scalefactor band gain for each frequency band; and
(d) adjusting a common gain to meet a target bit rate and matching a quantization noise curve to the approximated energy distribution curve while fixing the scalefactor band gain for each frequency band.

13. A computer-readable recording medium that records a program for executing a quantization noise distribution adjustment method on a computer, the method comprising the steps of:
(a) receiving a frequency domain audio signal, calculating an energy level for each frequency band of the frequency domain audio signal, approximating an energy distribution curve connecting the calculated energy levels to a distribution pattern of noise threshold levels calculated by a psychoacoustic model, and calculating a scalefactor band gain for each frequency band; and
(b) adjusting a common gain to meet a target bit rate and matching a quantization noise curve to the approximated energy distribution curve while fixing the scalefactor band gain for each frequency band.
